(19) United States
(12) Patent Application Publication
(10) Pub. No.: US 2026/0067407 A1
(43) Pub. Date: Mar. 5, 2026

(54) IMAGE FORMING SYSTEM, IMAGE FORMING APPARATUS, AND INSPECTION APPARATUS

(71) Applicant: CANON KABUSHIKI KAISHA, Tokyo (JP)

(72) Inventor: KENSUKE SASAKI, Chiba (JP)

(21) Appl. No.: 19/310,005

(22) Filed: Aug. 26, 2025

(30) Foreign Application Priority Data
Aug. 29, 2024 (JP) 2024-147980

(51) Int. Cl. H04N 1/00; G03G 15/00; G06T 7/00; H04N 1/387

(52) U.S. Cl. CPC H04N 1/00074; G03G 15/502; G03G 15/5062; G06T 7/0004; H04N 1/3877; G06T 2207/10008; G06T 2207/30144

(57) ABSTRACT

An image forming system includes an image forming apparatus configured to form an image on a sheet, an inspection apparatus configured to inspect the image formed on the sheet, a display configured to display an inspection result obtained by the inspection apparatus, and a controller configured to display a mark indicating an orientation of the inspected sheet and an inspection result image representing the inspection result, wherein the controller is configured to display the mark in accordance with an orientation in which the inspection result image is displayed.

### BACKGROUND

### Field of the Technology

The present disclosure relates to an inspection apparatus that performs an inspection of an image printed on a sheet, and an image forming system that includes such an inspection apparatus and an image forming apparatus.

### Description of the Related Art

An image forming apparatus generates a printed matter by printing an image on a sheet based on image data representing an image to be printed. An inspection apparatus which inspects an image of the printed matter inspects whether or not an image printed on a sheet by the image forming apparatus has been formed as instructed by image data. The inspection apparatus sets image data as reference data, and sets scan data obtained by reading an image printed on a sheet through use of a sensor such as a scanner as inspection image data to compare the reference data and the inspection image data to each other. The inspection apparatus determines print quality of a printed matter based on the degree of agreement between the reference data and the inspection image data.

In U.S. Pat. No. 11,513,745, there is disclosed a technology of simultaneously displaying a plurality of displays on one display screen when there is an abnormality (NG) at the time of determining print quality. The plurality of displays include displays of all print jobs, all jobs having abnormalities, and a region (NG portion) including an abnormal image and a type (dot stain, streak, or the like) of the abnormality on a predetermined printed matter in the jobs having abnormalities. In U.S. Pat. No. 11,094,048, there is disclosed a technology in which, when it is determined that the inspection result has an abnormality, an image (inspection result image) for showing the inspection result and an image obtained by displaying, in an enlarged manner, an image (abnormal image) of a portion determined to be abnormal in an inspection are displayed on a display screen.

### SUMMARY

An image forming system according to some embodiments of the present disclosure includes an image forming apparatus configured to form an image on a sheet, an inspection apparatus configured to inspect the image formed on the sheet a display configured to display an inspection result obtained by the inspection apparatus, and a controller configured to display a mark indicating an orientation of the inspected sheet and an inspection result image representing the inspection result, wherein the controller is configured to display the mark in accordance with an orientation in which the inspection result image is displayed.

An image forming apparatus according to another embodiment includes an image former configured to form an image on a sheet, a reader configured to read the sheet having the image formed thereon, an inspector configured to inspect an image of the sheet read by the reader, a display configured to display an inspection result obtained by the inspector, and a controller configured to display a mark indicating an orientation of the inspected sheet and an inspection result image representing the inspection result, wherein the controller is configured to display the mark in accordance with an orientation in which the inspection result image is displayed.

An inspection apparatus for inspecting an image formed on a sheet according to yet another embodiment includes a display, and a display controller configured to display an inspection result on the display, wherein the display is configured to display a mark indicating an orientation of the inspected sheet and an inspection result image representing the inspection result, and wherein the mark is displayed in accordance with an orientation in which the inspection result image is displayed.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming system.

FIG. 2 is a configuration diagram of a controller.

FIG. 3 is a configuration diagram of an inspection controller.

FIG. 4 is an explanatory view of a printing setting screen.

FIG. 5A and FIG. 5B are explanatory views of a result displaying screen.

FIG. 6A and FIG. 6B are explanatory views of a result displaying screen.

FIG. 7A and FIG. 7B are explanatory views of a result displaying screen.

FIG. 8 is a flow chart of inspection printing processing.

### DESCRIPTION OF THE EMBODIMENTS

Now, an embodiment of the present disclosure is described with reference to the drawings. The embodiment described below does not limit the appended claims, and not all combinations of features described in the embodiment are necessarily essential.

### <Configuration of Image Forming System>

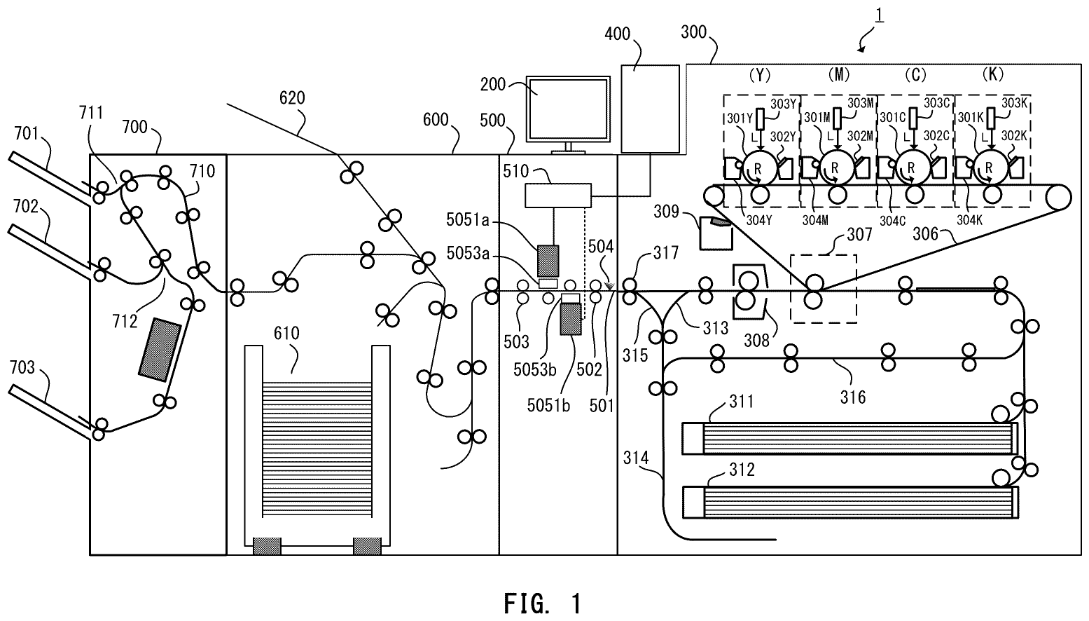

FIG. 1 is a configuration diagram of an image forming system including an inspection apparatus according to the embodiment. An image forming system 1 includes an operating device 200, a printer 300 serving as an image forming apparatus (which is also referred to as “printing apparatus”), a controller 400, an inspection apparatus 500 serving as an image inspector, a stacker 600, and a finisher 700 serving as a post-processor.

The operating device 200 is a user interface provided with an input interface and an output interface. The input interface is, for example, an input key and a touch panel. The output interface is, for example, a display and a speaker. Therefore, the operating device 200 also functions as means for presenting information through vision and hearing. The operating device 200 transmits, to the controller 400, an instruction and data that have been input from the input interface. In addition, the operating device 200 outputs information from the output interface in response to an instruction received from the controller 400.

The controller 400 controls operations of the printer 300, the inspection apparatus 500, the stacker 600, and the finisher 700 based on instructions and data that have been input from the operating device 200 or instructions and data that have been acquired from an external apparatus through a network. For example, to perform image formation, the controller 400 transmits an instruction for the image formation to the printer 300. Details of the controller 400 are described later.

### <Printer>

The printer 300 in the embodiment is a color image forming apparatus that prints a color image on a sheet, and functions as printing means. The printer 300 includes image forming units Y, M, C, and K, an intermediate transfer member 306, a transfer unit 307, a fixing device 308, sheet feeding cassettes 311 and 312, and a feeding mechanism for the sheet. The image forming unit Y forms an image of yellow (Y). The image forming unit M forms an image of magenta (M). The image forming unit C forms an image of cyan (C). The image forming unit K forms an image of black (K). The images of the respective colors formed by the image forming units Y, M, C, and K are transferred onto the intermediate transfer member 306 in a superimposed manner. The transfer unit 307 transfers the image borne on the intermediate transfer member 306 onto the sheet. The fixing device 308 fixes, to the sheet, the image transferred onto the sheet. The respective image forming units Y, M, C, and K have the same configuration, and form the images by the same operation. The following description is directed to a configuration of the image forming unit Y, and descriptions of configurations of the image forming units M, C, and K are omitted.

The image forming unit Y includes a photosensitive drum 301Y, a charger 302Y, an exposure device 303Y, and a developing device 304Y. The photosensitive drum 301Y is a drum-shaped photosensitive member including a photosensitive layer on a surface thereof. During an operation, the photosensitive drum 301Y is rotated in a direction indicated by an arrow R about a drum axis. The charger 302Y uniformly charges the surface of the photosensitive drum 301Y being rotated. The exposure device 303Y acquires image data representing an image of yellow from the controller 400, and emits and outputs a laser beam in accordance with the image data. The laser beam output from the exposure device 303Y scans the charged surface of the photosensitive drum 301Y in a drum axis direction.

The laser light scans the surface of the photosensitive drum 301Y being rotated, to thereby form an electrostatic latent image corresponding to the image data of yellow on the surface of the photosensitive drum 301Y. The developing device 304Y stores a yellow developer (e.g., toner), and uses the developer to develop the electrostatic latent image formed on the photosensitive drum 301Y. Thus, a yellow image is formed on the surface of the photosensitive drum 301Y. The developing device 304Y is configured so that a developer can be constantly supplied thereto from a toner cartridge (not shown).

In the same manner, a magenta image is formed on a photosensitive drum 301M of the image forming unit M. A cyan image is formed on a photosensitive drum 301C of the image forming unit C. A black image is formed on a photosensitive drum 301K of the image forming unit K.

The intermediate transfer member 306 is an endless belt member, and is rotated in a clockwise direction in FIG. 1. The intermediate transfer member 306 is in contact with the respective photosensitive drums 301Y, 301M, 301C, and 301K. In accordance with the rotation of the intermediate transfer member 306, the images of the respective colors are transferred from the respective photosensitive drums 301Y, 301M, 301C, and 301K in order so as to be superimposed one on another. Thus, a full-color image is formed on the intermediate transfer member 306. The intermediate transfer member 306 conveys the full-color image borne thereon to the transfer unit 307 by being rotated.

Sheets are stored in each of the sheet feeding cassettes 311 and 312, and are conveyed from the sheet feeding cassettes 311 and 312 to the transfer unit 307 by the feeding mechanism. A sheet is conveyed in accordance with a timing at which the image borne on the intermediate transfer member 306 is conveyed to the transfer unit 307. The transfer unit 307 transfers the image from the intermediate transfer member 306 onto the sheet. A cleaner 309 is arranged on a downstream side of the transfer unit 307 in a rotation direction of the intermediate transfer member 306. The cleaner 309 removes a developer remaining on the intermediate transfer member 306 after the transfer.

The sheet onto which the image has been transferred is conveyed from the transfer unit 307 to the fixing device 308. The fixing device 308 includes a heater and a pressure roller. The fixing device 308 uses heat from the heater and pressure from the pressure roller to melt the image and fix the image to the sheet.

Conveying paths 313, 314, and 315, a duplex conveying path 316, and discharge rollers 317 are provided on a downstream side of the fixing device 308 in a conveying direction of the sheet. The sheet that has passed through the fixing device 308 is temporarily conveyed from the conveying path 313 to the conveying path 314. After a trailing end of the sheet has passed through the conveying path 313, the conveying direction is reversed to convey the sheet from the conveying path 315 to the discharge rollers 317. With such conveyance, the sheet is discharged from the printer 300 by the discharge rollers 317 with an image-formed side facing downward (face down). A printed matter, which is the sheet that has been subjected to the image formation and discharged from the printer 300 by the discharge rollers 317, is passed over to the inspection apparatus 500.

In a case where duplex printing is to be performed on the sheet, the sheet conveyed to the conveying path 314 is conveyed to the duplex conveying path 316 after the trailing end has passed through the conveying path 313. The sheet is conveyed again to the transfer unit 307 through the duplex conveying path 316. Due to the passage through the duplex conveying path 316, a side of the sheet on which the image has been formed is turned over. The turned-over side of the sheet is subjected to image transferring processing by the transfer unit 307 and fixing processing by the fixing device 308, to thereby form an image on this side. The sheet having images formed on both sides is discharged as a printed matter from the printer 300 by the discharge rollers 317, and is passed over to the inspection apparatus 500.

### <Inspection Apparatus>

The inspection apparatus 500 includes a conveying path 501, an inspection controller 510, a first reader 5051a, a second reader 5051b, flow reading glasses 5053a and 5053b, conveying rollers 502 and 503 serving as conveying means, and a sheet detection sensor 504. Under the control of the controller 400, the inspection controller 510 controls the operation of the inspection apparatus 500. Details of the inspection controller 510 are described later. The first reader 5051a and the second reader 5051b are arranged at positions opposed to each other across the conveying path 501. The conveying rollers 502 and 503 convey the printed matter.

The inspection apparatus 500 detects the printed matter conveyed on the conveying path 501 by the sheet detection sensor 504, and the first reader 5051a and the second reader 5051b read the print images. The first reader 5051a and the second reader 5051b transmit reading results of the printed matter to the inspection controller 510. The inspection controller 510 performs a quality inspection of the images printed on the printed matter based on the reading results of the printed matter. The first reader 5051a and the second reader 5051b are arranged so as to be opposed to each other across the conveying path 501, and hence the images printed on both sides of the printed matter are read in one time of conveyance of the printed matter. The printed matter from which the images have been read is conveyed from the inspection apparatus 500 to the stacker 600.

### <Stacker and Finisher>

The stacker 600 includes a large-capacity tray 610 and a purge tray 620. The stacker 600 delivers a printed matter to any one of the large-capacity tray 610, the finisher 700, and the purge tray 620 based on an instruction received from the controller 400 and the results of the quality inspection performed by the inspection controller 510.

The finisher 700 includes a printed matter conveyor 710 including a plurality of conveying rollers and conveying paths, an upper-stage delivery tray 701, a middle-stage delivery tray 702, and a lower-stage delivery tray 703. The printed matter conveyor 710 includes switching mechanisms 711 and 712 for switching a delivery destination of the printed matter. The finisher 700 takes in printed matters from the stacker 600 in order, and delivers each of the printed matters to any one of the upper-stage delivery tray 701, the middle-stage delivery tray 702, and the lower-stage delivery tray 703 in response to an instruction received from the controller 400. The finisher 700 may be configured to perform post-processing, such as staple processing for binding and stapling a plurality of printed matters, bookbinding processing for the bound printed matters, and cut-off processing for the bound printed matters.

### <Controller>

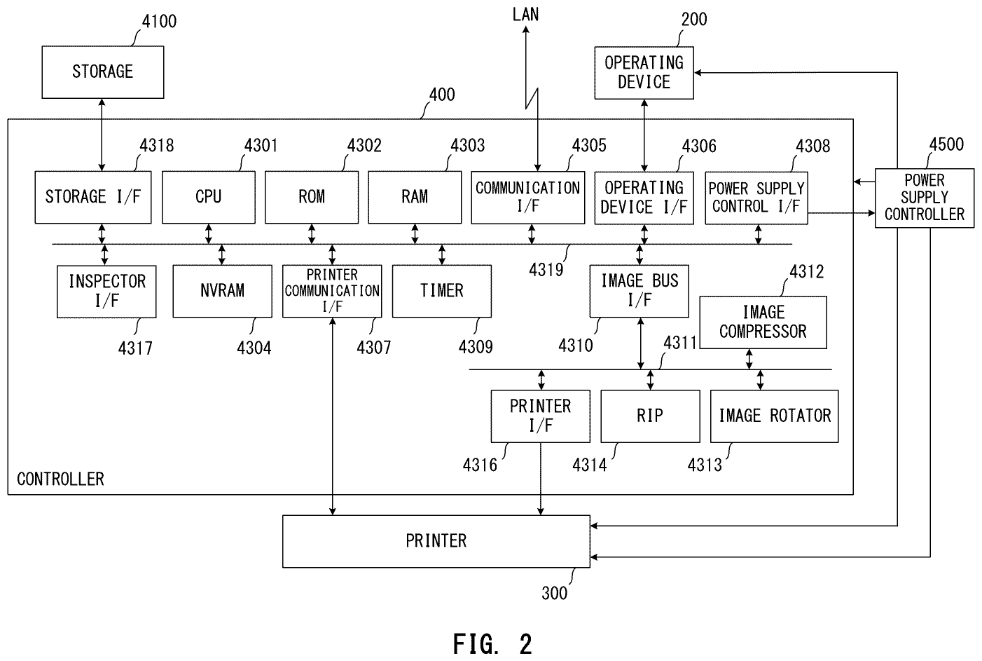

FIG. 2 is an explanatory diagram of a configuration of the controller 400. In addition to the printer 300, the inspection apparatus 500, and the operating device 200, the controller 400 is connected to a storage 4100 and a power supply controller 4500. The storage 4100 is a large-capacity storage device, such as a hard disk drive (HDD) or a solid state drive (SSD). As interfaces with the respective components to be connected, the controller 400 includes a storage I/F 4318, an operating device I/F 4306, a power supply control I/F 4308, an inspector I/F 4317, a printer communication I/F 4307, and a printer I/F 4316. The controller 400 also includes a communication I/F 4305 for communicating to/from an external apparatus through the network. The storage I/F 4318, the operating device I/F 4306, the power supply control I/F 4308, the inspector I/F 4317, the printer communication I/F 4307, and the communication I/F 4305 are connected to a system bus 4319.

The controller 400 includes a central processing unit (CPU) 4301, a read only memory (ROM) 4302, and a random access memory (RAM) 4303. The CPU 4301 executes a computer program stored in the ROM 4302 to control an operation of the image forming system 1. The RAM 4303 provides a work area for the CPU 4301 to execute processing. The RAM 4303 is also used as an image memory for temporarily storing image data and the like. The CPU 4301, the ROM 4302, and the RAM 4303 are also connected to the system bus 4319. A non-volatile RAM (NVRAM) 4304 and a timer 4309 are also connected to the system bus 4319. The NVRAM 4304 stores various parameters for control. The timer 4309 holds a current time, and monitors passage of a set time period.

The operating device I/F 4306 controls communication to/from the operating device 200. The operating device I/F 4306 receives input of print jobs, commands, and printing settings, which is performed from the operating device 200 to the controller 400, and transmits the input information to the CPU 4301. Under the control of the CPU 4301, the operating device I/F 4306 displays various screens and states of the image forming system 1 on a display of the operating device 200.

Under the control of the CPU 4301, the printer communication I/F 4307 controls communication to/from the printer 300. The power supply control I/F 4308 instructs the power supply controller 4500 to supply or stop various kinds of electric power in accordance with a command received from the CPU 4301. The power supply controller 4500 supplies electric power to the printer 300. Under the control of the CPU 4301, the inspector I/F 4317 controls communication to/from the inspection apparatus 500. Under the control of the CPU 4301, the storage I/F 4318 controls communication to/from the storage 4100.

The communication I/F 4305 is connected to a network such as a local area network (LAN), and performs communication control, such as transmission and reception of an email and inputting and outputting of PDL data from an external apparatus. The communication I/F 4305 also includes an NVRAM (not shown), and holds various parameters relating to communication control, such as a MAC address.

The system bus 4319 is connected to an image bus 4311 through an image bus I/F 4310. The image bus I/F 4310 is a bridge that connects the system bus 4319 and an image bus 4311 for transferring image data to the printer 300 to each other. A printer I/F 4316, an image compressor 4312, an image rotator 4313, and a raster image processor (RIP) 4314 are connected to the image bus 4311.

The image compressor 4312 performs compression and decompression processing for JPEG, JBIG, MMR, MH, and the like. The image rotator 4313 performs image rotation processing. The RIP 4314 expands PDL code into a bitmap raster image. The printer I/F 4316 transmits image data to the printer 300. This image data is generated by the controller 400 subjecting image data for print output to image processing for the printer 300, such as correction for the printer 300 and resolution conversion.

### <Inspection Controller>

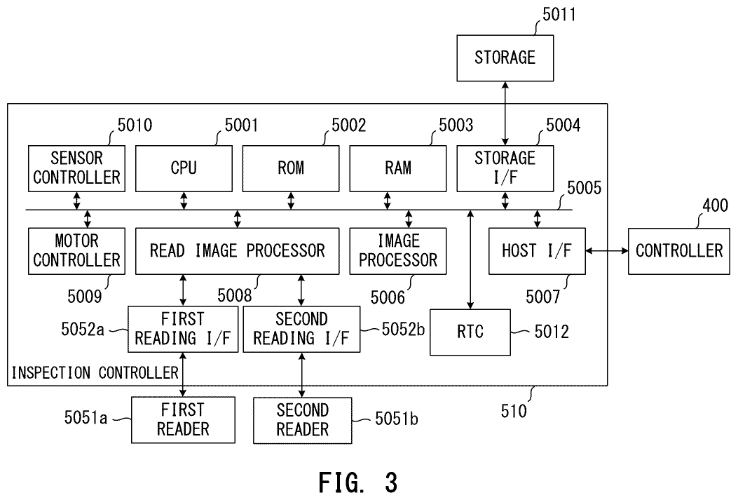

FIG. 3 is an explanatory diagram of a configuration of the inspection controller 510 provided to the inspection apparatus 500. The inspection controller 510 controls operations of the first reader 5051a and the second reader 5051b. The inspection controller 510 performs processing, such as analysis of the reading results from the first reader 5051a and the second reader 5051b, operation control of the inspection apparatus 500, and communication to/from the controller 400. The inspection controller 510 is also connected to a storage 5011, which is storage means for storing a misregistration correction profile and the like, and the controller 400.

The inspection controller 510 includes a CPU 5001, a ROM 5002, a RAM 5003, a storage I/F 5004, a motor controller 5009, a read image processor 5008, an image processor 5006, an RTC 5012, a host I/F 5007, and a sensor controller 5010. The respective components are connected to a system bus 5005. The read image processor 5008 is connected to the first reader 5051a through a first reading I/F 5052a, and is connected to the second reader 5051b through a second reading I/F 5052b. The RTC 5012 is a real-time clock, and holds the current time with high accuracy.

The host I/F 5007 controls communication to/from the inspector I/F 4317 of the controller 400. In a case where the inspection controller 510 and the controller 400 communicate to/from each other, data is transmitted and received between the host I/F 5007 and the inspector I/F 4317. For example, the host I/F 5007 acquires image data used for an image forming operation of the printer 300 from the controller 400. The storage 5011 is a large-capacity storage device, such as an HDD or an SSD. The image data can be stored in any location, but is stored in the storage 5011 in the embodiment.

The CPU 5001 executes a computer program stored in the ROM 5002 to control the operation of the inspection apparatus 500. The RAM 5003 provides a work area for the CPU 5001 to execute processing. The storage I/F 5004 controls communication to/from the storage 5011 connected to the inspection controller 510.

The read image processor 5008 is controlled by the CPU 5001 to acquire the reading result of the image on the printed matter from the first reader 5051a through the first reading I/F 5052a. The read image processor 5008 is also controlled by the CPU 5001 to acquire the reading result of the image on the printed matter from the second reader 5051b through the second reading I/F 5052b.

Under the control of the CPU 5001, the read image processor 5008 performs magnification processing, gamma correction processing, and the like on the reading results (read data) of the images on the printed matter, which have been acquired from the first reader 5051a and the second reader 5051b, to generate read image data, and stores the read image data in the RAM 5003. The first reader 5051a and the second reader 5051b are each provided with a sensor array, and are each capable of reading an entire region of the printed matter conveyed on the conveying path 501. The first reader 5051a reads an image on a first side of a printed matter, and the second reader 5051b reads an image on a second side of the printed matter.

The first reader 5051a and the second reader 5051b are each formed of a light emitter and a light receiver. The light emitter is formed of, for example, a white light emitting diode (LED), and the light receiver is formed of, for example, a CMOS sensor equipped with an RGB color filter. The light emitter is controlled by the CPU 5001 to irradiate the printed matter being conveyed along the conveying path 501 with light. The light receiver receives the light reflected by the printed matter by separating the light into three color components of RGB through use of a color filter, and outputs read data as a light reception result (reading result). The read data is transmitted to the read image processor 5008.

Under the control of the CPU 5001, the motor controller 5009 controls operations of various motors provided in the inspection apparatus 500. Under the control of the CPU 5001, the sensor controller 5010 controls the operations of various sensors provided in the inspection apparatus 500, and notifies the CPU 5001 of detection results from the sensors. The image processor 5006 is controlled by the CPU 5001 to compare the image data stored in the storage 5011 (hereinafter referred to as “reference image data”) to the read image data stored in the RAM 5003, to thereby perform a quality inspection of the printed matter. The reference image data is image data to be used by the printer 300 forming an image, and is stored in the storage 5011. The reference image data may be an image obtained by reading a reference image in advance before the quality inspection is performed. During the comparison, the image processor 5006 subjects the reference image data to correction processing using a parameter based on calibration described later.

### <Printing Settings>

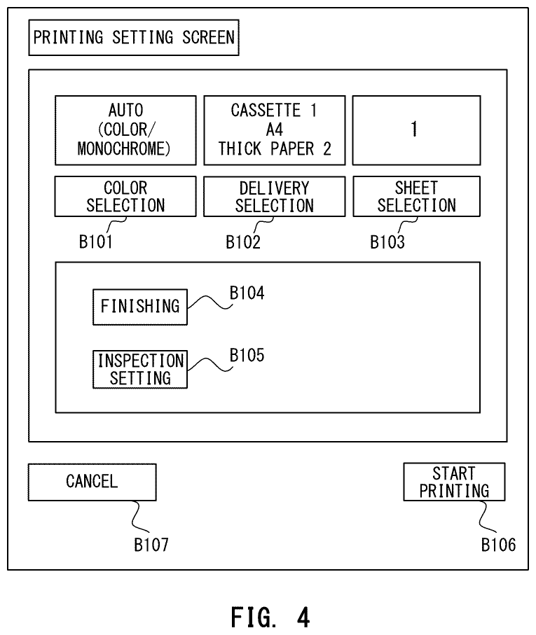

FIG. 4 is an explanatory view of an operation screen (printing setting screen) displayed on the display of the operating device 200 in order to instruct the printer 300 to perform printing. This operation screen allows a user to set quality inspection items and instruct execution of inspection printing processing through use of the operating device 200.

FIG. 4 indicates a state in which selection of color or monochrome is set to automatic selection, a cassette 1 is selected as a cassette for use, A4 is selected as a sheet size, thick paper 2 is selected as a type of paper, and 1 copy is selected as the number of copies to be printed. A button B101 to a button B103 are buttons for providing respective printing settings. The button B101 is a color selection button for selecting the color (color or monochrome) for printing, the button B102 is a delivery selection button for setting, for example, the delivery destination of the printed matter, and the button B103 is a sheet selection button for selecting a type of the sheet. In a case where the button B103 is pressed, for example, the size or the basis weight of the sheets stored in the sheet feeding cassettes 311 and 312 can be checked or changed, and the cassette that performs sheet feeding can be designated. A button B104 is a finishing button, and is a button for setting correction processing or the like using parameters by calibration. A button B105 is an inspection setting button, and, in a case where the button B105 is pressed by the user, the screen of the display transitions to an inspection setting screen (not shown). Further, the number of copies to be printed can be set through use of a numeric keypad (not shown). A button B106 is a printing start button, and, in a case where the button B106 is pressed, printing is started with the printing settings provided through the button B101 to the button B103 and the number of copies set through the numeric keypad, without performing a quality inspection by the inspection apparatus 500. A button B107 is a cancel button, and, in a case where the button B107 is pressed, the settings that have been input by the user are canceled, and an initial screen (not shown) is displayed on the display of the operating device 200.

### <Result Displaying Screen>

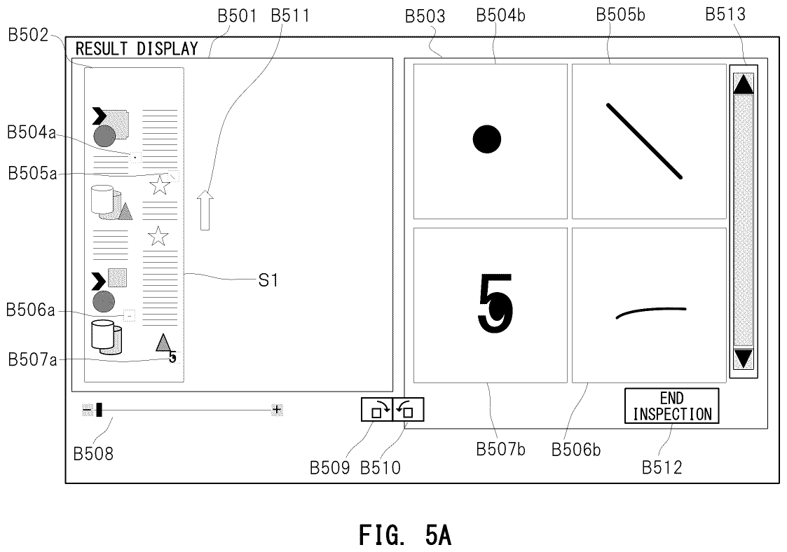

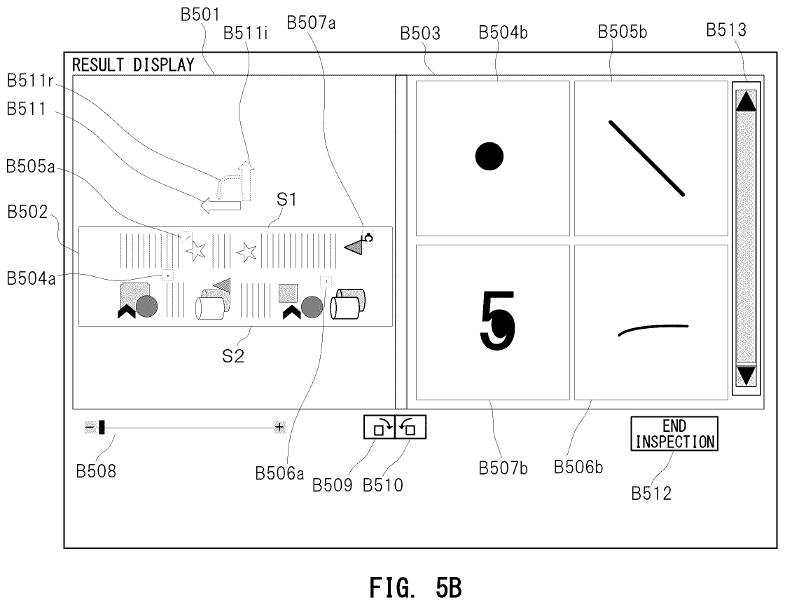

FIG. 5A and FIG. 5B are explanatory views for illustrating an example of a result displaying screen to be displayed on the display of the operating device 200 at the time of printing inspection NG of the printed matter. In this example, a long-size printed matter is used as the printed matter. In FIG. 5A and FIG. 5B, an area B501 is a region in which an inspection result image can be displayed. In this example, in the area B501, an image B502 is displayed as the inspection result image. The image B502 is an entire image of the printed matter determined as NG in the printing inspection. The image B502 includes, as four areas including images determined as NG in the printing inspection, areas B504a to B507a shown as regions surrounded by rectangular dotted lines in FIG. 5A and FIG. 5B. The area B504a is a region including a first abnormal image (image of a black dot in FIG. 5A and FIG. 5B) in the entire image determined as NG in the printing inspection. The area B505a is a region including a second abnormal image (image of a diagonal line in FIG. 5A and FIG. 5B) in the entire image determined as NG in the printing inspection. The area B506a is a region including a third abnormal image (image of a laterally long curve in FIG. 5A and FIG. 5B) in the entire image determined as NG in the printing inspection. The area B507a is a region including a fourth abnormal image (image in which the number “5” and a black dot are superimposed in FIG. 5A and FIG. 5B) in the entire image determined as NG in the printing inspection.

An area B503 is provided on the right side of the area B501. The area B503 is a region in which a partial image including the abnormal image in the image B502 can be displayed. In the illustrated example, an enlarged image of the abnormal image is shown as such a partial image. The partial image is only required to be an image including at least a part of the abnormal image. Thus, as the partial image, an enlarged image, an actual-size image, a reduced image, or the like of the entire abnormal image (or a part of the abnormal image) can be used. In the illustrated example, as the partial image, four enlarged images obtained by enlarging the entire abnormal images are displayed. An image B504b is an enlarged image of the first abnormal image in the area B504a. An image B505b is an enlarged image of the second abnormal image in the area B505a. The image B506b is an enlarged image of the third abnormal image in the area B506a. The image B507b is an enlarged image of the fourth abnormal image in the area B507a.

A slide bar B508 is a magnification changing bar for changing the magnification of the image B502. In a case where the slide bar B508 is moved to the right and the left, the magnification of the image displayed in the area B501 can be changed. Buttons B509 and B510 are each a rotation button for rotating the image B502, and have a function as an input portion for inputting a rotation operation. In a case where the button B509 is selected, the image B502 displayed in the area B501 can be rotated clockwise. In a case where the button B510 is selected, the image displayed in the area B501 can be rotated counterclockwise.

In FIG. 5A and FIG. 5B, an arrow B511 is shown as a mark indicating an orientation of the image B502. The arrow B511 has a start point (end portion without an arrowhead) and an end point (end portion with an arrowhead), and indicates an orientation of a conveying direction at the time of the inspection of the image B502. Further, the arrow B511 is only required to be displayed at a position that may be understood as indicating the orientation of the conveying direction of the image B502. In the illustrated example, the arrow B511 is displayed adjacent to the image B502 in the area B501. The conveying direction as used herein is a direction in which the printed matter is conveyed in a case where the printed matter is read by the sheet detection sensor 504. As another example, the arrow B511 may indicate a stacking direction of printed matters delivered to the delivery trays 701 to 703. In a case where the printed matter is not reversed after being read by the sheet detection sensor 504, the orientation of the stacking direction and the above-mentioned orientation of the conveying direction match each other. Meanwhile, in a case where the printed matter is reversed after being read by the sheet detection sensor 504, the orientation of the stacking direction is opposite to the above-mentioned orientation of the conveying direction.

FIG. 5A shows a result displaying screen in an initial state, before the image B502 is rotated by the buttons B509 and B510. The arrow B511 is displayed in the vicinity of the image B502. The vicinity as used herein refers to a position sufficiently close to the image B502 for the user to understand that the arrow B511 indicates the orientation of the image B502, for example, a position adjacent to the image B502. In the example of FIG. 5A, the image B502 has a polygonal shape (in this example, a quadrilateral shape), and the arrow B511 is displayed adjacent to one side of the image B502. Further, in this example, in a case where the image B502 is rotated through the buttons B509 and B510, the arrow B511 is rotated to follow a rotation direction and a rotation angle of the image B502 while maintaining a positional relationship relative to the image B502. In a case where the image of each of the inspection result image and the arrow is rotated, the image in the middle of rotation may be displayed as an animation, or an image after rotation may be displayed without displaying an image during rotation.

FIG. 5B shows a result displaying screen after the image B502 is rotated counterclockwise by 90 degrees through the button B510. The arrow B511 is rotated counterclockwise by 90 degrees while keeping the positional relationship relative to the image B502, and is displayed in the vicinity of a side S1 of the image B502 in FIG. 5B. Meanwhile, the images B504b to B507b are not rotated even in a case where the image B502 is rotated, and those images do not change in FIG. 5A and FIG. 5B.

As described above, the arrow B511 indicating the orientation of the conveying direction is displayed in the vicinity of the image B502, and the arrow B511 is rotated to follow the rotation of the image B502. Thus, the user can easily identify the orientation of the image B502 displayed on the display. In addition, the user can easily identify the positions of the images B504b to B507b in the image B502 based on the orientation of the image B502 displayed on the result displaying screen in the initial state, that is, the orientation before rotation, and the orientation of the image B502 displayed at present. Thus, with the arrow B511 being displayed as described above, the user can easily visually recognize and specify a portion at which an abnormal image is generated in the printed matter while identifying the orientation of the image B502 displayed at present and also identifying the actual orientation of the printed matter.

Further, in order to allow the user to more easily grasp the orientation of the image B502 before rotation, an arrow before rotation may be displayed in the vicinity of the arrow B511 after rotation. FIG. 5B shows the arrow before rotation as an arrow B511i. It is preferred that the arrow B511i and the arrow B511 be displayed in forms different from each other. In this manner, the user can distinguish the arrow B511i indicating the orientation before a rotation operation performed by the user and the arrow B511 indicating the orientation after the rotation operation. In the example of FIG. 5B, the arrow B511i is displayed by the dotted line, and can be easily discriminated from the arrow B511. It is preferred that, as illustrated in FIG. 5B, the arrow B511 be relatively emphasized by, for example, displaying the arrow B511i by a dotted line or a light color and displaying the arrow B511 by a solid line or a dark color. In this manner, it is made clearer that the arrow indicating the orientation of the image B502 after rotation is the arrow B511.

In a case where the arrow B511 after rotation and the arrow B511i before rotation are displayed, a mark indicating that the image B502 has been rotated may be further displayed. For this display, in FIG. 5B, an arc-shaped arrow B511r having the arrow B511i side as a start point and the arrow B511 side as an end point is further displayed as the mark indicating that the image B502 has been rotated. The orientation of the arc-shaped arrow B511r represents the rotation direction of the image B502, and hence the user can easily recognize that the arrow B511i indicates the direction before rotation and the arrow B511 indicates the direction after rotation. It is preferred that, as illustrated in FIG. 5B, the arrow B511 be relatively emphasized by, for example, displaying the arrow B511r by a dotted line or a light color and displaying the arrow B511 by a solid line or a dark color. In this manner, it is made clearer that the arrow indicating the orientation of the image B502 after rotation is the arrow B511.

In FIG. 5B, the arrow B511 is displayed in the vicinity of the side S1 of the image B502. The arrows B511i and B511r are disposed in the vicinity of the arrow B511, and hence all of the arrows B511, B511i, and B511r are displayed in the vicinity of the side S1 of the image B502 in FIG. 5B (in FIG. 5B, on the upper side of the image B502). The positions of the arrows B511, B511i, and B511r after rotation are not limited to those in this example, and may be displayed at any other positions as long as the arrows B511, B511i, and B511r are displayed at positions that allow the user to recognize the direction and the orientation of the image B502 after rotation. For example, those arrows B511, B511i, and B511r may always be displayed at the same position (for example, an upper right corner of the area B501 or the like). As another example, in FIG. 5B, the arrows B511, B511i, and B511r may be displayed in the vicinity of a side S2, which is a side opposed to the side S1 of the image B502.

A button B512 is an inspection end button. In a case where the confirmation of the printing inspection is ended and the user presses the button B512, the printing inspection can be ended. A scroll bar B513 is provided to change a display range of the enlarged image in the window of the area B503. That is, in a case where the number of enlarged images is large and the enlarged images cannot be fully accommodated in the window of the area B503, with the scroll bar B513 being moved in the up-down direction, the enlarged image displayed in the window of the area B503 is moved so that the display range can be changed.

In the example of FIG. 5A and FIG. 5B, the image to be rotated through the buttons B509 and B510 is the image B502, and the images B504b to B507b are not rotated. However, those images may be rotated in association with the image B502. This example is described in the following.

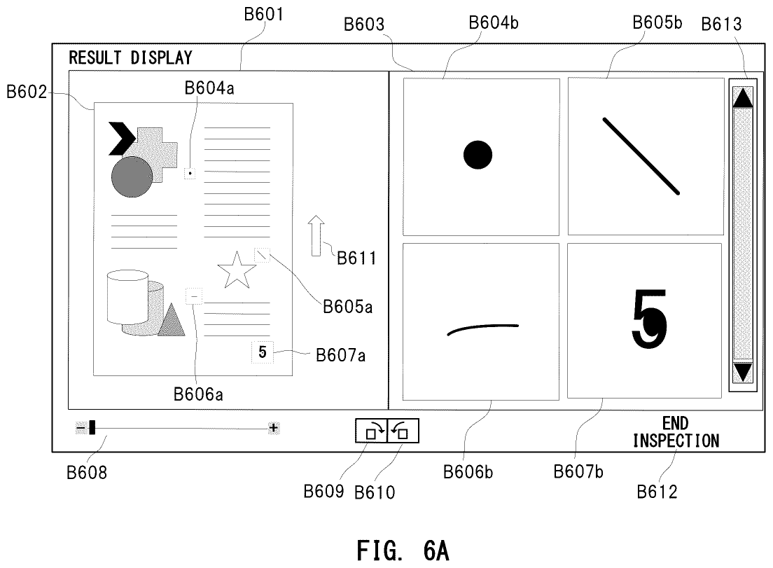

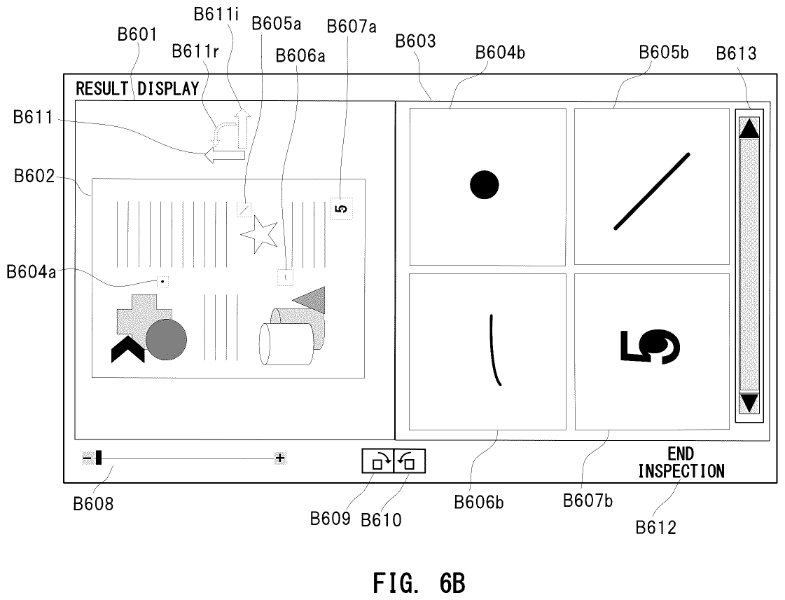

FIG. 6A and FIG. 6B are explanatory views for illustrating an example of the result displaying screen to be displayed on the display of the operating device 200 at the time of printing inspection NG of an A4-size printed matter. FIG. 5A and FIG. 5B show an example in which the entire image of the long-size printed matter is displayed, and, because the long-size printed matter has a large aspect ratio, the direction of the entire image can be relatively easily grasped. Meanwhile, the printed matter in the example of FIG. 6A and FIG. 6B has an A4 size, and it is more difficult to grasp the direction of the entire image as compared to the example of FIG. 5A and FIG. 5B.

An area B601 of FIG. 6A is a region in which, similarly to the area B501 of FIG. 5A, the inspection result image can be displayed. Further, an image B602 of FIG. 6B is, similarly to the image B502 of FIG. 5B, the entire image determined as NG in the printing inspection. Areas B604a to B607a of FIG. 6A and FIG. 6B are regions including, similarly to the areas B504a to B507a of FIG. 5A and FIG. 5B, first to fourth abnormal images in the entire image determined as NG in the printing inspection. Those areas are shown as regions surrounded by the rectangular dotted lines in FIG. 6A and FIG. 6B.

An area B603 is provided on the right side of the area B601. The area B603 is a region in which a partial image of the abnormal image in the image B602 can be displayed, and, in the illustrated example, four enlarged images obtained by enlarging the entire abnormal images are displayed as the partial image. An image B604b is an enlarged image of the first abnormal image in the area B604a. An image B605b is an enlarged image of the second abnormal image in the area B605a. An image B606b is an enlarged image of the third abnormal image in the area B606a. An image B607b is an enlarged image of the fourth abnormal image in the area B607a.

A slide bar B608 is a magnification changing bar for changing the magnification of the image B602, buttons B609 and B610 are each a rotation button for rotating the image B602, and an arrow B611 is a mark indicating the direction of the image B602 in the area B601. Those items are similar to the slide bar B508, the buttons B509 and B510, and the arrow B511 of FIG. 5A and FIG. 5B. An arrow B611i in FIG. 6B is a mark indicating the direction of the image B602 before rotation, and an arrow B611r is a mark (in this example, an arrow) having the arrow B611i side as a start point and the arrow B611 side as an end point. Those arrows are similar to the arrows B511i and B511r of FIG. 5B, and are displayed to emphasize that the arrow B611i indicates the direction before rotation and the arrow B611 indicates the direction after rotation. Further, the display of the arrow B511i and the arrow B511r by dotted lines and light colors is also similar.

A button B612 is an inspection end button. In a case where the confirmation of the printing inspection is ended and the user presses the button B612, the printing inspection can be ended. A scroll bar B613 is provided to change a display range of the enlarged image in the window of the area B603. Those items are similar to the button B512 and the scroll bar B513 of FIG. 5A and FIG. 5B.

FIG. 6A shows the result displaying screen in the initial state, before the image B602 is rotated through the buttons B609 and B610. The arrow B611 is displayed in the vicinity of the side S1 of the image B602 of FIG. 6A. Similarly to FIG. 5A and FIG. 5B, in a case where the image B602 is rotated through the buttons B609 and B610, the arrow B611 is rotated to follow the rotation direction and the rotation angle of the image B602 while maintaining the positional relationship relative to the image B602.

FIG. 6B is an explanatory view for illustrating a state after the button B610 is selected and pressed in FIG. 6A. In FIG. 6B, similarly to FIG. 5B, the image B602 is displayed in the area B601 under a state of being rotated counterclockwise by 90°, and the arrow B611 is rotated to follow the rotation direction of the image B602. That is, the orientation of the arrow B611 is changed from the upper direction of FIG. 6A to the left direction. Moreover, the display position of the arrow B611 is changed to the upper side of the image B602.

Meanwhile, unlike the images B504b to B507b of FIG. 5A and FIG. 5B, the first to fourth enlarged images displayed in the images B604b to B607b are each rotated to follow the rotation of the image B602. Thus, the images B604b to B607b of FIG. 6B are displayed under a state of being rotated counterclockwise by 90° similarly to the image B602. As described above, the orientation of the abnormal image in each of the areas B604a to B607a and the orientation of each of the images B604b to B607b match each other, and hence the user can easily recognize that both of those images are images for the same defective image.

In the examples of FIG. 5A and FIG. 5B and FIG. 6A and FIG. 6B, the arrows B511 and B611 are displayed as marks in the vicinity of the image B502 and the image B602. However, a mark (in those examples, an arrow) indicating the direction and the orientation of the image may be displayed for each of the images B504b to B507b and the images B604b to B607b which are enlarged images of the abnormal images. In this case, an upward arrow is displayed for each of the images B504b to B507b of FIG. 5A and FIG. 5B and the images B604b to B607b of FIG. 6A, and a leftward arrow is displayed for each of the images B604b to B607b of FIG. 6B.

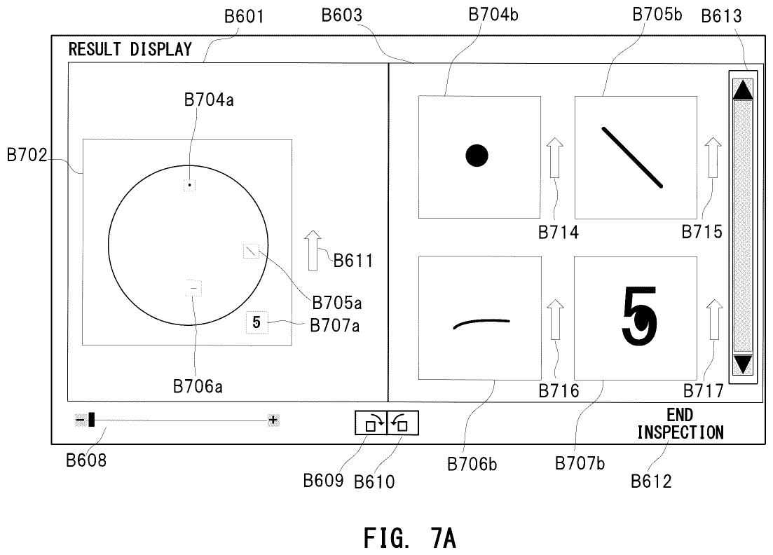

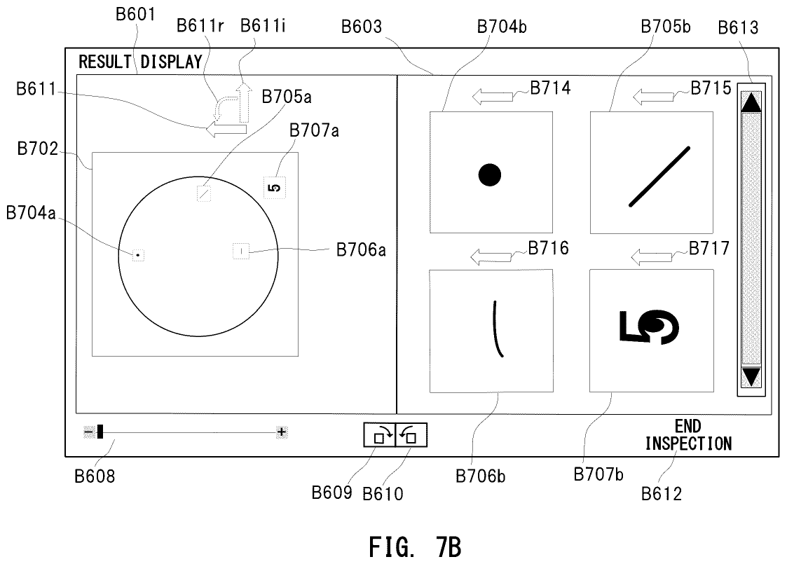

FIG. 7A and FIG. 7B show an example of a case in which an inspection image is a symmetrical figure. Examples of the symmetrical figure include a vertically symmetrical figure, a laterally symmetrical figure, a line symmetrical figure, and a point symmetrical figure, but, in this example, an example of a circle which is a figure having a high symmetry property is shown. In FIG. 7A and FIG. 7B, an image B702 is, similarly to the image B602 of FIG. 6A and FIG. 6B, the entire image determined as NG in the printing inspection. The image B702 is a vertically and laterally symmetrical figure in which a circle is drawn. Areas B704a to B707a of FIG. 7A and FIG. 7B are regions including, similarly to the areas B604a to B607a of FIG. 6A and FIG. 6B, first to fourth abnormal images in the entire image determined as NG in the printing inspection. Further, images B704b to B707b are enlarged images obtained by enlarging the entire abnormal images. Elements common to FIG. 6A and FIG. 6B (such as the area B601 and the arrow B611) are denoted by the same reference symbols, and description thereof is omitted.

In a case where the user rotates the image B702 on the result displaying screen, there is a fear that the user cannot tell the orientation in the present display. In particular, in a case where the symmetry property of the image B702 is high, it becomes difficult to identify its orientation. However, in FIG. 7A and FIG. 7B, the arrow B611 is displayed, and hence the orientation of the image B702 can be easily grasped.

Moreover, in FIG. 7A and FIG. 7B, arrows B714 to B717 are displayed as a mark indicating the direction of each image also for the respective images B704b to B707b. Those arrows B714 to B717 are rotated in accordance with the rotation of the image B702 so as to become the same orientation as that of the arrow B611. The arrows B714 to B717 are displayed also for the respective images B704b to B707b that are enlarged images, and thus the user can easily identify not only the orientation of the image B702 but also the orientations of the images B704b to B707b. There may also be employed a configuration in which an arrow having the same orientation as that of the arrow B611 is displayed not for all of the images B704b to B707b but for at least one thereof.

In FIG. 7B, the arrows B714 to B717 of the images B704b to B707b are also rotated in accordance with the rotation of the image B702. However, as a modification example, in FIG. 7B, the arrows B714 to B717 can be displayed without being rotated similarly to FIG. 7A.

Further, in FIG. 7A and FIG. 7B, an arrow before rotation and a mark indicating that the image has been rotated may be further displayed for each of the arrows B714 to B717. In this case, in a case where the arrow B714 is taken as an example, similarly to the arrow B611i and the arrow B611r for the arrow B611 of FIG. 6B, an arrow indicating the orientation before rotation and an arc-shaped arrow indicating the rotation direction are further displayed. The same holds true also for the arrows B715 to B717.

### <Printing Inspection Processing Flow>

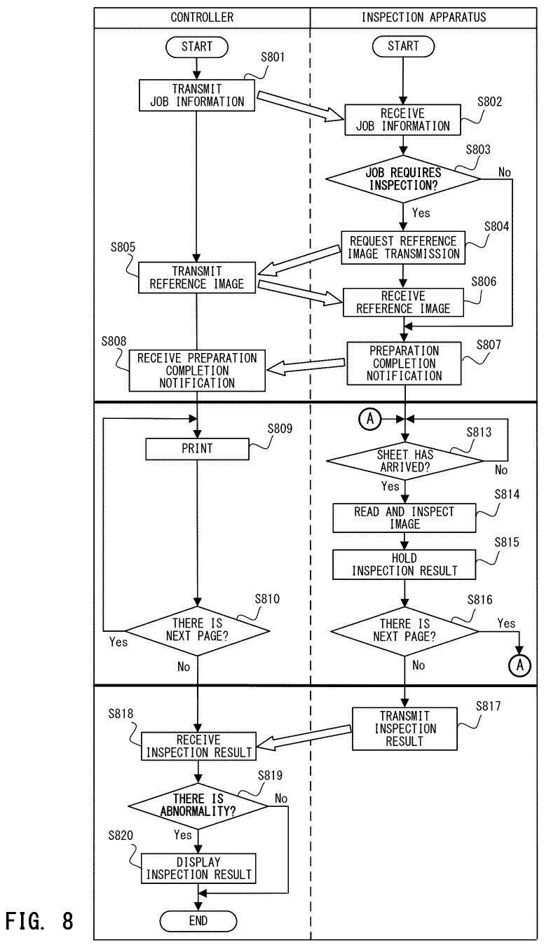

FIG. 8 is a flow chart of inspection printing processing of main printing. In this flow chart, processing to be executed by the CPU 4301 of the controller 400 and processing to be executed by the CPU 5001 of the inspection apparatus 500 are collectively illustrated. In FIG. 4, in a case where the user selects and presses the button B106, which is the printing start button, the CPU 4301 of the controller 400 is instructed to execute the inspection printing, and the inspection printing is executed in accordance with the instruction.

In a case where the button B106 is selected through the operating device 200, the CPU 4301 of the controller 400 transmits, to the inspection apparatus 500, job information including, for example, sheet information for use in printing, inspection settings, and a delivery destination determined by the inspection result (Step S801). The CPU 5001 of the inspection apparatus 500 receives the job information from the controller 400 (Step S802), and then determines, from the received job information, whether or not the print job is a job requiring an inspection (Step S803). In a case where the job requires an inspection, (Step S803: Yes), the CPU 5001 of the inspection apparatus 500 transmits, to the controller 400, a reference image transmission request for inspection determination (Step S804). In a case where the job does not require an inspection (Step S803: No), the process proceeds to Step S807.

The CPU 4301 of the controller 400 transmits original image data of the print job as reference image data to the inspection apparatus 500 based on the reference image transmission request received from the inspection apparatus 500 (Step S805). The CPU 5001 of the inspection apparatus 500 receives the reference image from the controller 400 to store the reference image in the storage 5011 (Step S806). The CPU 5001 of the inspection apparatus 500 notifies the controller 400 of completion of preparation for the print job through completion of reception of the reference image (Step S807). In a case where the CPU 4301 of the controller 400 receives a preparation completion notification from the inspection apparatus 500 (Step S808), the CPU 4301 controls the printer 300 to start printing (Step S809), and determines whether there is a next page (Step S810). When there is a next page (Step S810: Yes), the process returns to Step S809, and the CPU 4301 executes printing of the next page. When there is no next page (Step S810: No), the process advances to Step S818 to be described later.

Meanwhile, after the execution of Step S807, the CPU 5001 of the inspection apparatus 500 determines whether or not a sheet has arrived at a sheet detection position of the sheet detection sensor 504 on the conveying path 501 of the inspection apparatus 500 (Step S813). In a case where a sheet has not arrived (No in Step S813), the CPU 5001 of the inspection apparatus 500 waits for a sheet to arrive. In a case where a sheet has arrived (Yes in Step S813), the CPU 5001 of the inspection apparatus 500 reads the sent sheet by the first reader 5051a and the second reader 5051b and then instructs the image processor 5006 to perform processing for comparison to the reference image data received in Step S806. Accordingly, the image processor 5006 performs the processing for comparison to perform an image inspection (Step S814). Then, the CPU 5001 of the inspection apparatus 500 holds an inspection result obtained through comparison by the image processor 5006 into the RAM 5003 (Step S815). After that, the CPU 5001 of the inspection apparatus 500 determines whether or not there is printing of the next page from the received job information (Step S816). When there is a next page (Step S816: Yes), the CPU 5001 of the inspection apparatus 500 executes the processing steps from Step S813 again to continue the inspection processing, and, when there is no next page (Step S816: No), the process proceeds to Step S817 to be described later.

The CPU 5001 of the inspection apparatus 500 transmits, to the controller 400, the inspection result held in Step S815 (Step S817). The CPU 4301 of the controller 400 receives the inspection result from the CPU 5001 of the inspection apparatus 500 (Step S818), and determines whether or not there is NG in the received inspection results (Step S819). When there is no NG (Step S819: No), the CPU 5001 of the inspection apparatus 500 ends this printing inspection processing. When there is NG (Step S819: Yes), the CPU 5001 of the inspection apparatus 500 advances to inspection result display processing (Step S820).

In the inspection result display processing, the CPU 4301 of the controller 400 controls the operating device 200 to display the above-mentioned result displaying screen. In a case where the user selects the inspection end button after confirming the abnormal portion, the CPU 4301 of the controller 400 ends this printing inspection processing.

In the above-mentioned example, a configuration using an arrow as a mark for indicating the orientation of the inspection result image has been employed, but figures having other shapes may be used as long as the user can understand the direction of the image. Further, the mark is not limited to a still image, and a figure with animation such as an animation GIF image, a moving image, and the like can be used. For example, there may be employed an appropriate configuration such as a configuration in which a V-shaped figure is used as the mark and a distal end of the V shape is directed to the conveying direction or the upstream side or the like, or a configuration in which a figure obtained by arranging a plurality of V-shaped figures is used as the mark. Further, for the arrows B511, B511i, B611, and B611i, a moving image in which a mark (for example, an arrow or a V-shaped figure) moves in the orientation of the conveying direction can be used to indicate the orientation of the inspection image. Similarly, also for the arrows B511r and B611r, a moving image in which a figure moves from the start point to the end point of the arrow can be used as a mark to indicate the rotation direction of the inspection image. As described above, an animation can be provided to indicate the orientation or the direction, and hence not only a mark having the start point and the end point that are distinguishable such as an arrow but also a mark having the start point and the end point that are undistinguishable such as a line segment can be used.

Further, in the above-mentioned example, the directions of the arrows B511 and B611 are the conveying direction of the printed matter. However, as long as the portion at which an abnormality has occurred in the printed matter can be easily identified by the user, the directions are not limited to the conveying direction, and directions defined with other references can be used. For example, as the direction of the arrow B511, in addition to the conveying direction described above, the user can set the direction of the arrow through the operation screen of the operating device 200. For example, the user can set a direction obtained by rotating the conveying direction by any angle (for example) 90° as the orientation of the arrow.

In a case where FIG. 5A and FIG. 5B are taken as an example, the user can easily recognize the rotation angle of the image B502 displayed at present from the orientation of the image B502 while recognizing the orientation of the image B502 in the result displaying screen in the initial state. Thus, even when the image B502 is rotated, the user can easily specify the position at which an abnormality has occurred in the image B502 (the positions of the first abnormal image to the fourth abnormal image in the image B502) while recognizing the orientation of the arrow B511 before rotation and the orientation of the arrow B511 after rotation. As a result, no matter from which reference the arrow B511 before rotation is defined, the position at which the abnormality has occurred can be easily specified in the actual printed matter. The rotation angle of the image B502 is 90° in FIG. 5B and FIG. 6B, but the rotation angle is not limited thereto and may be any angle. Further, there has been employed a configuration in which the arrow B511 or the like is arranged adjacent to the images B502 and B602 that are inspection result images in the same area, but the present disclosure is not limited thereto. The arrow B511 or the like can be arranged in another area of the result displaying screen, or can be arranged at a position separated from the inspection result image.

In the above-mentioned example, the arrows B511 and B611 are displayed in the vicinity of the respective images B502 and B602 that are inspection results, and no arrow is displayed for the partial image. However, for each of the images B504b to B507b and B604b to B607b that are partial images (enlarged images) or for at least one thereof, the arrows B511 and B611 may be displayed in the vicinity of one side thereof. The same holds true also for the arrows B511i and B611i indicating an arrow before rotation and the arrows B511r and B611r indicating the rotation direction.

In the example of FIG. 5B, the arrows B511, B511i, and B511r may be displayed in the vicinity of each of the images B504b to B507b that are partial images (enlarged images) or at least one thereof. Similarly, also in the example of FIG. 6B, the arrows B611, B611i, and B611r may be displayed in the vicinity of each of the images B604b to B607b that are partial images (enlarged images) or at least one thereof.

As described above, according to this embodiment, it is possible to easily identify the orientation of the inspection result image displayed on the display screen, and to instantly grasp an approximate position of the abnormal image in the inspection result image. Accordingly, in the inspection result screen, even in a case where the inspection result image is rotated, the user can easily match orientations of the printed matter and the image at the time of comparing the printed matter and the image on the screen, and reduction in usability in the display of the inspection result image can be suppressed. Further, as a result, the work time can be shortened.

The inspection apparatus 500 may be provided as a stand-alone device independently of the image forming system 1. In this case, the inspection controller 510 of the inspection apparatus 500 is connected to the controller 400 so as to enable communication therebetween. The inspection apparatus 500 also includes the operating device including the display for displaying the inspection result display screen and the input interface for receiving input from the user. In the processing of FIG. 8, the inspection controller 510 (CPU 5001) executes the processing steps of Step S819 and Step S820 subsequently to the processing step of Step S816, and also performs display control of the inspection result displaying screen on the display.

The inspection apparatus 500 may also have an in-line configuration provided inside the printer 300. In this case, the first reader 5051a, the second reader 5051b, and the flow reading glasses 5053a and 5053b are provided downstream of the fixing device 308, and read the sheet to which the image has been fixed by the fixing device 308. The function of the inspection controller 510 is provided to the controller 400.

The image forming system 1 according to this embodiment is configured to display the inspection result display screen on the display of the operating device 200, but the inspection result display screen may be displayed on a display of another apparatus. For example, the inspection result display screen may be configured to be displayed on a display of an external apparatus such as a personal computer connected to the image forming system 1 through the communication I/F 4305 so as to enable communication therebetween.

As described above, in the inspection apparatus, in some cases, an operation of rotating the inspection result image is required on the screen of displaying the inspection result image. In a case where the inspection result image is rotated, in some cases, the correspondence relationship between the orientation of the inspected sheet and the orientation in which the inspection result image is displayed becomes difficult to understand, and the usability is reduced. According to the present disclosure, the reduction in usability in the display of the inspection result image can be suppressed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-147980, filed Aug. 29, 2024, which is hereby incorporated by reference herein in its entirety.

What is claimed is:

1. An image forming system comprising:
an image forming apparatus configured to form an image on a sheet;
an inspection apparatus configured to inspect the image formed on the sheet;
a display configured to display an inspection result obtained by the inspection apparatus; and
a controller configured to display a mark indicating an orientation of the inspected sheet and an inspection result image representing the inspection result,
wherein the controller is configured to display the mark in accordance with an orientation in which the inspection result image is displayed.

2. The image forming system according to claim 1, wherein the controller is configured to display, in a case where the inspection result includes an abnormal image, a partial image including the abnormal image together with the inspection result image on the display.

3. The image forming system according to claim 1, wherein the controller is configured to:
display, on the display, an input portion for inputting a rotation operation of the inspection result image; and
in a case where the rotation operation is input through the input portion, display the inspection result image rotated from a first direction that is an orientation before the rotation operation to a second direction that is an orientation after the rotation operation, and display the mark in an orientation rotated from the first direction to the second direction.

4. The image forming system according to claim 3, wherein the controller is configured to display, on the display, the mark before the rotation operation and the mark after the rotation operation in forms different from each other.

5. The image forming system according to claim 4, wherein the controller is configured to display, on the display, together with the mark after the rotation operation and the mark before the rotation operation, the mark indicating a rotation direction of the inspection result image.

6. The image forming system according to claim 1, wherein the controller is configured to display the mark adjacent to one side of the inspection result image.

7. The image forming system according to claim 2, wherein the controller is configured to display a first mark adjacent to one side of the inspection result image, and display a second mark adjacent to one side of the partial image.

8. The image forming system according to claim 1, wherein an orientation of the mark is a conveying direction of the sheet at the time of reading the sheet in a case where the sheet is inspected.

9. The image forming system according to claim 1, wherein an orientation of the mark is a stacking direction of the sheet after the sheet is delivered.

10. The image forming system according to claim 2, wherein the controller is configured to:
display, on the display, an input portion for inputting a rotation operation of the inspection result image;
in a case where the rotation operation is input through the input portion, display the inspection result image rotated from a first direction that is an orientation before the rotation operation to a second direction that is an orientation after the rotation operation, and display the mark in an orientation rotated from the first direction to the second direction;
display a first mark adjacent to one side of the inspection result image and display a second mark adjacent to one side of the partial image; and
in a case where the inspection result image is displayed as being rotated in the second direction, display the first mark in an orientation rotated to the second direction, and display the second mark in an orientation maintained in the first direction.

11. The image forming system according to claim 2, wherein the controller is configured to:
display, on the display, an input portion for inputting a rotation operation of the inspection result image;
in a case where the rotation operation is input through the input portion, display the inspection result image rotated from a first direction that is an orientation before the rotation operation to a second direction that is an orientation after the rotation operation, and display the mark in an orientation rotated from the first direction to the second direction;
display a first mark adjacent to one side of the inspection result image and display a second mark adjacent to one side of the partial image; and
in a case where the inspection result image is displayed as being rotated in the second direction, display the first mark in an orientation rotated to the second direction, and display the second mark in an orientation rotated to the second direction.

12. An image forming apparatus comprising:
an image former configured to form an image on a sheet;
a reader configured to read the sheet having the image formed thereon;
an inspector configured to inspect an image of the sheet read by the reader;
a display configured to display an inspection result obtained by the inspector; and
a controller configured to display a mark indicating an orientation of the inspected sheet and an inspection result image representing the inspection result,
wherein the controller is configured to display the mark in accordance with an orientation in which the inspection result image is displayed.

13. An inspection apparatus for inspecting an image formed on a sheet, the inspection apparatus comprising:
a display; and
a display controller configured to display an inspection result on the display,
wherein the display is configured to display a mark indicating an orientation of the inspected sheet and an inspection result image representing the inspection result, and
wherein the mark is displayed in accordance with an orientation in which the inspection result image is displayed.

14. The inspection apparatus according to claim 13, wherein the display is configured to display, in a case where the inspection result includes an abnormal image, a partial image including the abnormal image together with the inspection result image.

15. The inspection apparatus according to claim 13, wherein the display controller is configured to:
display, on the display, an input portion for inputting a rotation operation of the inspection result image; and
in a case where the rotation operation is input through the input portion, display the inspection result image rotated from a first direction that is an orientation before the rotation operation to a second direction that is an orientation after the rotation operation, and display the mark in an orientation rotated from the first direction to the second direction.

16. The inspection apparatus according to claim 15, wherein the display controller is configured to display, on the display, the mark before the rotation operation together with the mark after the rotation operation.

17. The inspection apparatus according to claim 16, wherein the display controller is configured to display, on the display, together with the mark after the rotation operation and the mark before the rotation operation, the mark indicating a rotation direction of the inspection result image.

18. The inspection apparatus according to claim 13, wherein the display controller is configured to display the mark adjacent to one side of the inspection result image.

19. The inspection apparatus according to claim 14, wherein the display controller is configured to display a first mark adjacent to one side of the inspection result image, and display a second mark adjacent to one side of the partial image.

20. The inspection apparatus according to claim 13, wherein an orientation of the mark is a conveying direction of the sheet at the time of reading the sheet in a case where the sheet is inspected.

21. The inspection apparatus according to claim 13, wherein an orientation of the mark is a stacking direction of the sheet after the sheet is delivered.

22. The inspection apparatus according to claim 14, wherein the display controller is configured to:
display, on the display, an input portion for inputting a rotation operation of the inspection result image;
in a case where the rotation operation is input through the input portion, display the inspection result image rotated from a first direction that is an orientation before the rotation operation to a second direction that is an orientation after the rotation operation, and display the mark in an orientation rotated from the first direction to the second direction;
display a first mark adjacent to one side of the inspection result image, and display a second mark adjacent to one side of the partial image; and
in a case where the inspection result image is displayed as being rotated in the second direction, display the first mark in an orientation rotated to the second direction, and display the second mark in an orientation maintained in the first direction.

23. The inspection apparatus according to claim 14, wherein the display controller is configured to:
display, on the display, an input portion for inputting a rotation operation of the inspection result image;
in a case where the rotation operation is input through the input portion, display the inspection result image rotated from a first direction that is an orientation before the rotation operation to a second direction that is an orientation after the rotation operation, and display the mark in an orientation rotated from the first direction to the second direction;
display a first mark adjacent to one side of the inspection result image, and display a second mark adjacent to one side of the partial image; and
in a case where the inspection result image is displayed as being rotated in the second direction, display the first mark in an orientation rotated to the second direction, and display the second mark in an orientation rotated to the second direction.
